(19) United States
(12) Patent Application Publication
(10) Pub. No.: US 2025/0386228 A1
(43) Pub. Date: Dec. 18, 2025

(54) METHODS, DEVICES, AND MEDIUM FOR COMMUNICATION

(71) Applicant: NEC Corporation, Tokyo (JP)

(72) Inventors: Gang WANG, Beijing (CN); Peng GUAN, Beijing (CN); Yukai GAO, Beijing (CN); Wei CHEN, Beijing (CN)

(73) Assignee: NEC Corporation, Tokyo (JP)

(21) Appl. No.: 18/877,607

(22) PCT Filed: Jun. 23, 2022
(86) PCT No.: PCT/CN2022/100915

§ 371 Date: Dec. 20, 2024

(51) Int. Cl. H04W 24/10

(52) U.S. Cl. CPC H04W 24/10

(57) ABSTRACT

Example embodiments of the present disclosure relate to beam reporting based on artificial intelligence prediction. In an example method, the method of communication at the terminal device comprising: receiving a configuration for a first beam report from a network device; generating, the first beam report using an artificial intelligence (AI) model without performing a beam measurement on a first set of reference signals associated with the first beam report; and transmitting the first beam report to the network device. In this way, the payload of the beam report may be reduced, thus save the uplink resource.

### FIELD

Example embodiments of the present disclosure generally relate to the field of telecommunication, and in particular, to a terminal device, a network device, methods, apparatuses and a computer readable storage medium for communication.

### BACKGROUND

In a wireless access network, a network device may produce a set of beams to a terminal device. The terminal device may transmit a beam report to the network device, to indicate a beam or a subset of beams with better performance than the other beams. But in generating the beam report, the terminal needs to measure a reference signal (RS) from the network device, and needs to report a reference signal quality information to the network device. This needs more payload in the report, thus needs more resource in uplink. The transmitting of reference signal from the network device also needs more resource in downlink.

### SUMMARY

In general, example embodiments of the present disclosure provide a solution for beam reporting based on artificial intelligence prediction.

In a first aspect, there is provided a method of communication at a terminal device. The method comprises: receiving a configuration for a first beam report from a network device; generating, the first beam report using an artificial intelligence (AI) model without performing a beam measurement on a first set of reference signals associated with the first beam report; and transmitting the first beam report to the network device.

In a second aspect, there is provided a method of communication at a network device. The method comprises: transmitting a configuration for a first beam report to a terminal device; and receiving, the first beam report for the network device from the terminal device, the first beam report being generated using an artificial intelligence (AI) model without performing a beam measurement on a first set of reference signals associated with the first beam report.

In a third aspect, there is terminal device. The terminal device comprises: a processor; and a memory storing computer program codes; the memory and the computer program codes configured to, with the processor, cause the terminal device to perform the method in the first aspect.

In a fourth aspect, there is network device. The network device comprises: a processor; and a memory storing computer program codes; the memory and the computer program codes configured to, with the processor, cause the network device to perform the method in the second aspect.

In a fifth aspect, there is provided a computer readable medium having instructions stored thereon, the instructions, when executed by a processor of an apparatus, causing the apparatus to perform the method in the first and second aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates an example of a process flow for beam reporting based on artificial intelligence prediction in accordance with some example embodiments of the present disclosure;

FIG. 2 illustrates an example of a process flow for beam reporting based on artificial intelligence prediction in accordance with some example embodiments of the present disclosure;

FIG. 3 illustrates an example of a process flow for beam reporting based on artificial intelligence prediction in accordance with some example embodiments of the present disclosure;

FIG. 4 illustrates an example of a process flow for beam reporting based on artificial intelligence prediction in accordance with some example embodiments of the present disclosure;

FIG. 5 illustrates an example of a process flow for beam reporting based on artificial intelligence prediction in accordance with some example embodiments of the present disclosure;

FIG. 6 illustrates an example of a process flow for beam reporting based on artificial intelligence prediction in accordance with some example embodiments of the present disclosure;

FIG. 7 illustrates an example of a process flow for beam reporting based on artificial intelligence prediction in accordance with some example embodiments of the present disclosure;

FIG. 8 illustrates an example of a method implemented at a terminal device in accordance with some example embodiments of the present disclosure;

FIG. 9 illustrates an example of a method implemented at a network device in accordance with some example embodiments of the present disclosure;

FIG. 10 illustrates a simplified block diagram of a device that is suitable for implementing embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(s) that work together to cause an apparatus, such as a mobile phone or server, to perform various functions) and
(c) hardware circuit(s) and or processor(s). such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA). High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME). USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal” may be used interchangeably.

In a wireless access network, a network device may produce a set of beams to a terminal device. The terminal device may transmit a beam report to the network device, to indicate a beam or a subset of beams with better performance than the other beams. But in generating the beam report, the terminal needs to measure a reference signal from the network device, and needs to report reference signal quality information with an indication of the reference signal to the network device. This needs more payload in the report, thus needs more resource in uplink. The transmitting of reference signal from the network device also needs more resource in downlink.

Example embodiments of the present disclosure provide a mechanism to solve the above discussed issues. The inventor finds that if the terminal device generates the beam report without measuring the reference signal, while using location information of the terminal device, and the beam report may only comprise the indicator of the reference signal generated with artificial intelligence (AI) prediction, without the reference signal quality information. In this way, the payload of the beam report may be reduced, thus save the uplink resource. The beam report may be produces in a model inference. Accordingly, the network device does need to transmit the reference signal all the time, thus save the downlink resource In a model monitoring, the reference signal may be measured, as well as the AI prediction, to determine whether the AI model is available. An indication of whether the AI model is available can be carried in the beam report. Principles and some example embodiments of the present disclosure will be described in detail below with reference to the accompanying drawings.

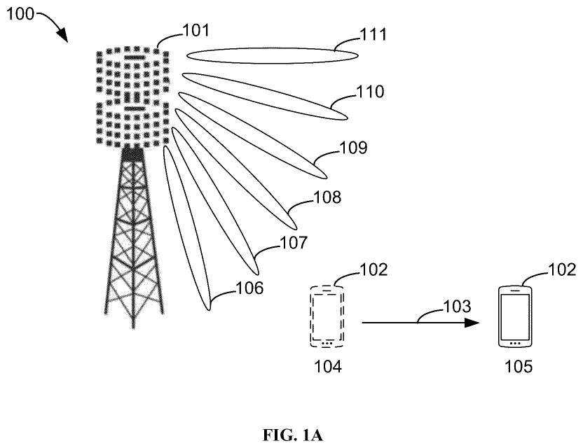

FIG. 1A illustrates an example of a network environment in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more network devices, and terminal devices that communicate with one another. It should be appreciated, however, that the description herein may be applicable to other types of apparatus or other similar apparatuses that are referenced using other terminology.

The communication system 100 includes a network device 101, and a terminal device 102. According to example embodiments of the present disclosure, the network device 101 may produce a set of beams, such as 106, 107, 108. 109. 110, and 111. Those skilled in the art can understand that the number of potential beams may be different with the number of beams in FIG. 1, such as 8, 16, or 32, etc. Associated with each beam, there is a reference signal. The reference signal can be Channel State Information-Reference Signal (CSI-RS). Alternatively or additionally. the reference signal can be Synchronization Signal (SS)/Physical Broadcast Channel (PBCH). CRI-RS and SS/PBCH associated with the set of beams can be comprised in a set of reference signals There is a Channel State Information (CSI)—Reference Signal (RS) Resource Indicator (CRI) for each CSI-RS, and a Synchronization Signal (SS)/Physical Broadcast Channel (PBCH) Block Resource Indicator (SSBRI) for each SS/PBCH. So the CRI, SSBRI can indicate the beam associated with it.

In example embodiments of the present disclosure, the terminal device 102 moves from location 104 to location 105, with a direction or trajectory 103. Using AI or machine learning (ML) model prediction, without measuring the set of reference signals from the network device 101, only with location information of the terminal device 102, the terminal device 102 may determine a first set of beams, with better reference signal quality than the other beams in the set of beams. The first set of beams can be one beam, such as 107, or a subset of beams. such as 107, 108, 109, and 110. So in a first beam report, the terminal may only report CRI or SSBRI of beam 107, or CRIs or SSBRIs of the subset of beams 107, 108. 109, 110, without performing beam measurement on a first set of reference signals associated with the first set of beams. A bit width of the first beam report can be determined by the number of CRIs or SSBRIs to be reported. The first beam report may also be generated with the direction or trajectory of the terminal device 102.

FIG. 1B illustrates an example of a process flow for beam reporting based on artificial intelligence prediction in accordance with some example embodiments of the present disclosure. In example embodiments of the present disclosure, the network device 101 transmits (111) a configuration for a first beam report to the terminal device 102. Upon receiving (111) the configuration, the terminal device 102 generates (112) the first beam report using an artificial intelligence (AI) model without performing a beam measurement on a first set of reference signals associated with the first beam report. Then, the terminal device 102 transmits (113) the first beam report to the network device 101. Accordingly. the network device 101 receives (113) the first beam report 113 from the terminal device 102. This way, the resource of beam report can be reduced, thus reduce the resource in uplink.

In example embodiments of the present disclosure, although RSs are configured in

the first beam report 113 generated with AI model, the terminal device 102 can ignore or omit the RSs if the network work device transmits the RSs. In other words, the terminal device 102 does not receive the RSs, or does not perform beam measurement (i.e. calculate the L1-RSRPs of the beams corresponding to the received RSs and find the top N beams based on the calculated L1-RSRPs). The terminal device 102 is not expected to receive the RSs associated with the AI beam report.

In example embodiments of the present disclosure, due to reception of the RSs is unnecessary for the terminal device 102, it can be considered that network device 101 does not transmit the RSs though the RSs has been configured in the AI beam report. The terminal device 102 does not expect to receive the RSs associated with the AI beam report.

In example embodiments of the present disclosure, for a triggered first beam report based on AI, the terminal device 102 reports only CRIs/SSBRIs (e.g., CIRs/SSBRIs corresponding to the predicted top N beams) to gNB even if the report quantity of the AI beam report is configured as “cri-RSRP” or “ssb-Index-RSRP”. N refers to a positive integer greater than or equal to 1. The value of N can be configured or indicated by gNB. and possibly depends on a capability reported by UE. The capability refers to the maximum number of beams that the AI model can predict.

This way, the terminal device 102 does not need to transmit beam report with reference signal quality information, to reduce the resource in uplink. In example embodiments of the present disclosure, in order to determine the top N (N>=1) beams out of the set of beams, the terminal device 102 calculates the Layer 1 Reference Signal Received Powers (L1-RSRPs) and Layer 1 Signal to Interference plus Noise Ratios (L1-SINRs) corresponding to a set of RSs (i.e., corresponding to the set of beams) associated with the beam report.

In example embodiments of the present disclosure, for first beam report with AI, the corresponding bitwidth is determined according to N CRIs/SSBRIs to be reported. The terminal device 102 can report the CRIs/SSBRIs corresponding to the predicted top N beams in Uplink Control Information (UCI) or Physical Uplink Control Channel (PUCCH) according to a mapping order applied for reporting only CRI/SSBRI. The mapping order of the CRIs/SSBRIs can be as follows.

The following table may be implemented as beam report, with CRI or SSBRI. Those skilled in the art can understand that the beam report can be in another format, such as with different field name, etc. This way, the bitwidth of the beam report can be reduced, to reduce the resource in uplink.

| CSI report number | CSI field |
|---|---|
| CSI report #n | CSI or SSBRI #1, if reported |
| | CSI or SSBRI #2, if reported |
| | . . . |
| | CSI or SSBRI #N, if reported |

The first beam report can also carry reference signal quality information with prediction, such as L1-RSRP and L1-SINR. The bitwidth of the first beam report can also be determined by L1-RSRP and L1-SINR.

In example embodiments of the present disclosure, the terminal device 102 can also generate and transmit beam report, by measuring the reference signals from the network device 101, without AI/ML model prediction. When the first beam report based on AI conflicts with another beam report in time domain, the priority needs to be determined according to: whether the two beam reports carry only CRI or SSBRI, whether the two beam reports is configured as an AI beam report.

The terminal device 102 can be configured to transmit a plurality of beam reports generated with AI model periodically or semi-persistently. The first beam report may be one of the pluralities of beam reports. The terminal device 102 can also be triggered by the network device 101, to transmit the beam report at any time. The first beam report may conflict with a second beam report. The terminal device 102 can determine a first priority of the first beam report, and a second priority of the second beam report. The first priority can be determined by whether the first beam report comprises only CRIs or SSBRIs. The second priority can be determined by whether the second beam report comprises only CRIs or SSBRIs.

In example embodiments of the present disclosure, priority of beam report carrying only CRI/SSBRI can be less than that of beam report carrying L1-RSRP/L1-SINR. In example embodiments of the present disclosure, a priority value k of the beam report can be determined as following: k=0 for the beam report carrying L1-RSRP, L1-SINR, and CRIS or SSBRIs, and k=1 for beam report carrying only CRIs or SSBRIs, without L1-RSRP or L1-SINR. The priority with value k=0 is higher than the priority with value k=1.

In example embodiments of the present disclosure, priority of beam report carrying only CRI/SSBRI can be less than that of beam report carrying L1-RSRP/L1-SINR. In example embodiments of the present disclosure, the first beam report based on AI conflicts with another beam report carrying CRI/SSBRI+L1-RSRP/L1-SINR (i.e., the PUCCH/Physical Uplink Share Channel (PUSCH) resources overlaps carrying the first beam report based on AI with the PUCCH/PUSCH resource carrying another beam report), the terminal device can prioritize the transmission of another beam report.

In example embodiments of the present disclosure, k=0 for only carrying L1-RSRP, L1-SINR, k=1 for carrying L1-RSRP. L1-SINR, and CRIs or SSBIRs, k=2 for only carrying CRIs or SSBIRs. The priority value of k=0 is higher than the priority value of k=1, and the priority value of k=1 is higher than the priority value of k=2.

In example embodiments of the present disclosure, priority of AI beam report that is configured as an AI beam report can be less than that of beam port is not configure with an AI beam report. For example, the AI beam report carrying also CRI+L1-RSRP conflicts with another beam report carrying CRI+L1-RSRP, the terminal device can prioritize the transmission of another beam report. This way, the beam report with RS measurement with more information can be transmitted with higher priority.

Alternatively or additionally, the first priority can be determined by whether the first beam report is generated using the AI model The second priority can also be determined by whether the second beam report is generated using the AI model as well. The priority without AI model is higher than that with AI model.

In example embodiments of the present disclosure. if the terminal device 102 receives the RSs associated with the AI beam report between the AI beam report and the latest AI beam report, the terminal device 102 reports CRI/SSBRI+L1-RSRP/L1-SINR. The corresponding bitwidth is determined based on the K CRIs/SSBRIs+L1-RSRPs/L1-SINRs to be reported.

In example embodiments of the present disclosure, if the terminal device 102 does not receive the RSs associated with the AI beam report between the AI beam report and the latest AI beam report, the terminal device 102 reports only CRI/SSBRI. The corresponding bitwidth is determined based on the N CRIs/SSBRIs to be reported.

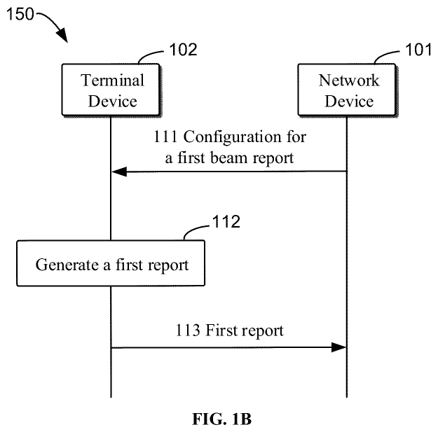

FIG. 2 illustrates an example of a process flow for beam reporting based on artificial intelligence prediction in accordance with some example embodiments of the present disclosure In example embodiments of the present disclosure, at 201, the network device 101 transmits a configuration of first beam report, or triggers first beam report. At 202, the network device 101 transmits reference signal such as CRI-RS or SSB to the terminal device 102. At 203, the terminal device 102 implements beam measurement, with reception of the reference signal. At 204, the terminal device 102 transmits non-AI based beam report, with CRI/SSBRI and L1-RSRP/L1-SINR. At 205, without reference signal measurement, the terminal device 102 implements model inference. At 206, the terminal device transmits the first beam report. with only CRI/SSBRI.

In the following blocks 205, 207, and 209, the terminal device 102 implements model inference without reference signal, then transmits the first beam report at 206, 208, and 210. At 211, the network device 101 transmits reference signal such as CRI-RS or SSB to the terminal device 102. At 212, the terminal device 102 implements beam measurement. with reception of the reference signal. At 213, the terminal device 102 transmits non-AI based beam report, with CRI/SSBRI and L1-RSRP/L1-SINR. The period of reference signal 214 is different with the period of beam report 215. In example embodiments of the present disclosure, the period of reference signal 214 can be 40 slots, and the period of beam report 215 can be 10 slots.

In example embodiments of the present disclosure, the terminal device 102 can transmit periodically or semi-persistently (P/SP) a plurality of beam reports. The first beam report can be one of the pluralities of beam reports. In example embodiments of the present disclosure, the period of the P/SP AI beam report is configured as 10 slots and the period of the RSs is configured as 40 slots. Before the first and fifth beam report, the terminal device 102 will receive the RSs (or is configured or provided with the RSs), in this case, the terminal device 102 performs beam measurement based on the received RSs and reports CRIs+L1-RSRPs corresponding to the top K (e.g., K=1/2/3/4) beams. But for the second, third, fourth and sixth beam report, the terminal device 102 will not receive the RSs (or is not configured or provided with the RSs), in this case, the terminal device 102 does not perform beam measurement and reports only CRIs corresponding to the predicted top N beams based on AI model.

In example embodiments of the present disclosure, more strictly, the terminal device 102 needs to determine whether the RSs are received between the AI beam report (i.e. current beam report or beam report to be reported or transmitted) and the latest AI beam report. Specifically, between the first symbol or slot of the PUCCH/PUSCH resource carrying the AI beam report or CSI reference resource corresponding to the AI beam report and the last symbol or slot of the PUCCH/PUSCH resource carrying the latest AI beam report. This way, the terminal device can generate more accurate beam report with RSs measurement.

In example embodiments of the present disclosure, the first beam report using AI model may not be configured with the RSs. Though the reception of the RSs is unnecessary for the terminal device, the terminal device 102 can know the configuration information of the RSs, such as the number or identity of CSI-RS/SSB resource sets or CSI-RS/SSB resources. The first set of reference signals associated with the first beam report can be determined based on a second set of reference signals configured in a second beam report. The second beam report can be closest to the first beam report in time domain. Alternatively or additionally, the second beam report can be generated using the AI model, or not using the AI model. Alternatively or additionally, the number of the second set of RSs configured in the second beam report is less than or equal to a predefined threshold. The predefined threshold is used to indicate the maximum number of beams that AI model can support. Alternatively or additionally, the second beam report is indicated by an index of a CSI report configured in the first beam report. Or, the first RSs can be determined based on the RSs configured in the indicated second beam report.

In example embodiments of the present disclosure, the RSs (called as “first RSs”) associated with the AI beam report (“first beam report”) can be determined based on the RSs (“second RSs”) configured in another beam report (“second beam report”). The second beam report needs to satisfy at least one of the following criteria: the second beam report is the beam report latest to the first beam report in time domain, the second beam report is not an AI beam report, i.e. non-AI beam report, the number of RSs configured in the second beam report is less than or equal to a predefined threshold, which is used to indicate the maximum number of beams that AI model can support.

In example embodiments of the present disclosure, the second beam report is indicated by an ID or index of CSI report indicating the second beam report and the ID or index of CSI report is configured in the first beam report. In other words, the first RSs can be determined based on the RSs configured in the indicated second beam report.

In example embodiments of the present disclosure, the RSs associated with the AI beam report can be determined based on RSs (called as “third RSs”) satisfying at least one of the following criteria: the RS resource set corresponding to the third RSs is associated or configured with repetition (e.g., repetition off or on), the RS resource set corresponding to the third RSs is the RS resource set latest to the first beam report in time domain, the number of third RSs is less than or equal to the predefined threshold. This way, the terminal device can get the RS configuration without configuration.

In example embodiments of the present disclosure, for an AI beam report, the bitwidth for report quantities (e.g., CRI/SSBRI) can be determined according to the RSs associated with the beam report. For example, the determination of the bitwidth for reporting CRI/SSBRI depends to the number of the RSs configured in the beam report. When the terminal device 102 is not configured with the RSs configured in the AI beam report, the terminal device 102 can determine the RSs associated with the AI beam report firstly based on the previous second beam report, and then determine the bitwidth for reporting CRI/SSBRI based on the number of the determined RSs.

The bitwidth for CRI, SSBRI, RSRP and different RSRP can be determined as following tables.

| Field | Bitwidth |
|---|---|
| CRI | [log₂(Kₛ^{CSI-RS})] |
| SSBRI | [log₂(Kₛ^{ssb})] |
| RSRP | 7 |
| Differential RSRP | 4 |

where

$${K}_{s}^{CSI - RS}$$

is the number of CSI-RS resources in the corresponding resource set or the associated resource set, and

$${K}_{s}^{S S B}$$

is the configured number of SS/PBCH blocks in the corresponding resource set or the associated resource set for reporting “ssb-Index-RSRP”. This way, the bitwidth of CRI, SSBRI, RSRP and differential RSRP can be determined, to reduce the resource in uplink.

In example embodiments of the present disclosure, the terminal device 102 can determine that the beam report is an AI beam report, if at least one of the following conditions is met: the terminal device 102 reports AI-related capabilities, e.g., capabilities indicating that the terminal device supports AI/ML, model inference, beam prediction based on position information. The terminal device 102 is configured with AI-related configuration by the network device, e.g., enable parameters indicating AI/ML/model inference/beam prediction based on position information. The terminal device 102 is not configured with the RSs associated with the beam report, the period of the RSs configured in the beam report is different from the period of the beam report. The period of the RSs configured in the beam report is different from the period of the beam report.

This way, the resource of the beam report can be reduced, and the resource of uplink can be reduced.

In example embodiments of the present disclosure, for the first beam report, model inference can be used to predict CRI, SSBRI, RSRP with AI model, and model monitoring can be used to monitor whether the AI model is available. For monitoring-based reporting, the terminal device 102 reports at least CRI and a first information to the network device, wherein the first information is used to indicate whether the AI model is available or not. Specifically, the terminal device 102 can report: K/N CRIs, K/N L1-RSRPs and the first information, i.e., CRIs and L1-RSRPs corresponding to the top K/N beams and the first information. The terminal device 102 can report K/N CRIs the first information. The first information occupies 1 bit in the UCI. “1” means that the AI model is available. “0” means that the AI model is not available. The beam report with the first information can be as the following tables.

| Field | Bitwidth |
|---|---|
| CRI | [log₂(Kₛ^{CSI-RS})] |
| SSBRI | [log₂(Kₛ^{ssb})] |
| RSRP | 7 |
| Differential RSRP | 4 |
| First Information | 1 |

| CSI report number | CSI field |
|---|---|
| CSI report #n | CSI or SSBRI #1, if reported |
| | CSI or SSBRI #2, if reported |
| | . . . |
| | CSI or SSBRI #N, if reported |
| | First Information |
| CSI report #n | CSI or SSBRI #1, if reported |
| | CSI or SSBRI #2, if reported |
| | CSI or SSBRI #3, if reported |
| | CSI or SSBRI #4, if reported |
| | RSRP #1, if reported |
| | Differential RSRP #2, if reported |
| | Differential RSRP #3, if reported |
| | Differential RSRP #4, if reported |
| | First Information |

In example embodiments of the present disclosure, for inference-based reporting, the terminal device 102 reports at least CRI to the network device. Specifically, the terminal device can report N CRIs. The terminal device can also report N CRIs and N L1-RSRPS.

For monitoring-based reporting, the terminal device 102 is expected to receive the RSs associated with the joint model inference and model monitoring (JIM) beam report. For inference-based reporting, the terminal device is not expected to receive the RSs associated with the JIM beam report. This way, the monitoring based reporting can carry the availability of the AI model with only one bit, to reduce the uplink resource.

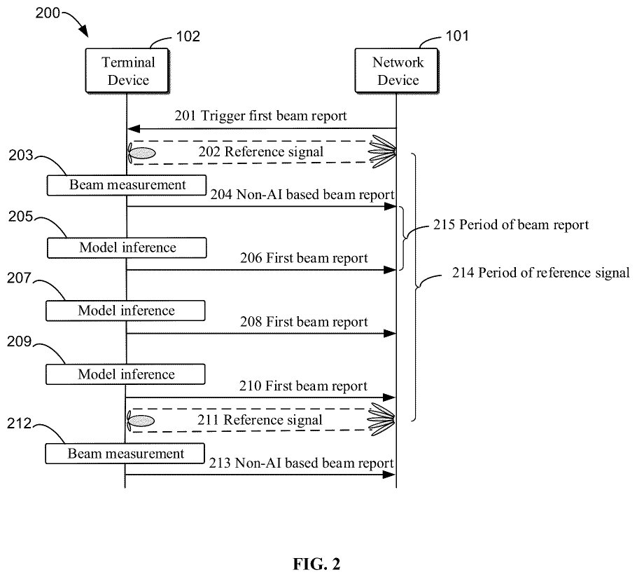

FIG. 3 illustrates an example of a process flow for beam reporting based on artificial intelligence prediction in accordance with some example embodiments of the present disclosure. In example embodiments of the present disclosure, the first beam report transmitted by the terminal device 102 is of a first reporting type for model inference, without measurement of the RSs. A third beam report can be in a second reporting type for model monitoring.

In model monitoring, the terminal device 102 measures the RSs from the network device 101, and calculates the L1-RSRPs or L1-SINRs, as well as CRIs/SSBRIs. In model monitoring, the terminal device 102 can also generate CRIs/SSBRIs with the AI model, as well as the L1-RSRPs or L1-SINRs, with location information of the terminal device 102. By comparing the CRIs, SSBRIs, L1-RSRPs, L1-SINRs measured from the RSs, and generated by the AI model, it can be determined whether the AI model is available. The terminal device 102 can transmit an indication of whether the AI model is available in the third beam report. The beam report carrying the indication of whether the AI model is available can be a second reporting type for model monitoring.

In example embodiments of the present disclosure, at 301, the network device 101 transmit a configuration for a first beam report to the terminal device 102, using AI model, without performing beam measurement on the set of the RSs associated with the first beam report. At 302, the network device 101 transmits the RSs to the terminal device 102. At 303, the terminal device implements model monitoring, then transmits a third beam report for model monitoring to the network device 101 at 304. At 305, without reception and measurement of the RSs, the terminal device 102 implements model inference, and transmits the first beam report for model inference to the network device 101 at 306. In the following blocks 307 and 309, the terminal device 102 implements model inference, then transmits the first beam report for model inference to the network device 101 at 308 and 310. After reception of the RSs at 311, the terminal device 102 implements beam monitoring at 312. then transmits the third beam report for model monitoring.

In example embodiments of the present disclosure, the terminal device 102 can determine the reporting type to be model monitoring by an offset for model monitoring and a period for model monitoring. In FIG. 3, the offset for model monitoring can be 0, and the period for model monitoring can be 40 slots. The offset for model inference can be 0, and the period for model inference can be 10 slots. Based on this configuration information, the terminal device can determine whether the JIM beam report is monitoring-based reporting or inference-based beam reporting. Further. the monitoring specific offset and period can be configured in the JIM beam report. Optionally, it can also be considered to configure an inference specific offset and period. This way, the timing of beam report of model inference and model monitoring can be controlled so flexibly.

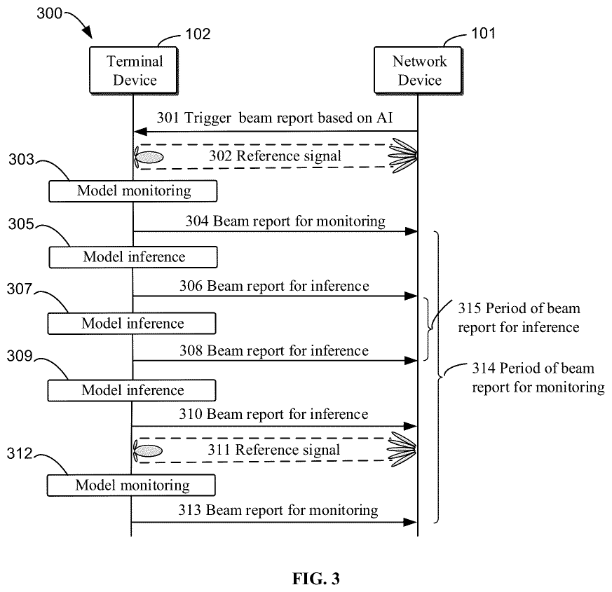

FIG. 4 illustrates an example of a process flow for beam reporting based on artificial intelligence prediction in accordance with some example embodiments of the present disclosure. In example embodiments of the present disclosure, the operations 301, 302, . . . , and 313 in FIG. 4 are the same with those in FIG. 3. The terminal device 102 can determine the reporting type to be model monitoring by a cycle duration. The offset and period of the JIM beam report are 0 and 10 slots. Furthermore, the terminal device is configured with the cycle duration. Assuming the start offset and period of the cycle duration are configured as 0 and 40 slots.

And the cycle duration further includes an inference duration (e.g. 30 slots) and a monitoring duration (e.g., 10 slots), in which the inference duration can be front of or behind the monitoring duration. As shown in FIG. 4, the terminal device enters the inference duration firstly. And during the inference duration, the JIM beam report is inference-based reporting. It means that the terminal device does not receive the RSs and report at least CRI. Then, the terminal device enters the monitoring duration. And during the monitoring duration, the JIM beam report is monitoring-based reporting. It means that the terminal device receives the RSs and report at least CRI and the first information. This way, the timing of beam report of model inference and model monitoring can be controlled so flexibly.

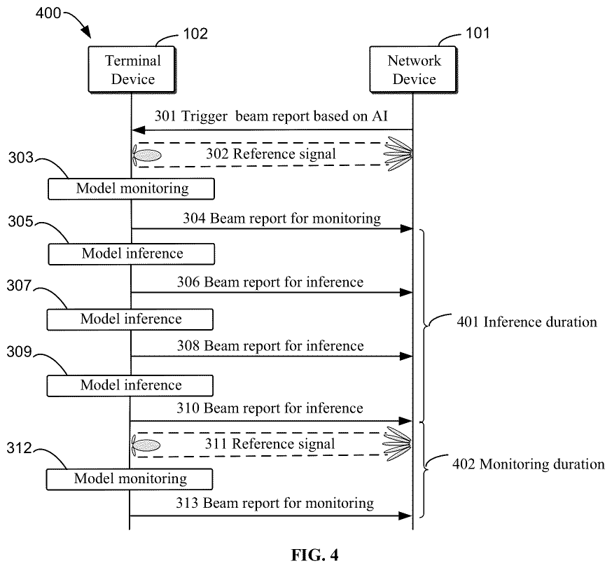

FIG. 5 illustrates an example of a process flow for beam reporting based on artificial intelligence prediction in accordance with some example embodiments of the present disclosure. In example embodiments of the present disclosure, the operations 301, 302, . . . , and 313 in FIG. 5 are the same with those in FIG. 3. The terminal device 102 can determine the reporting type to be model monitoring by a dynamic indication from the network device 101. In FIG. 5, the dynamic indication can be the indications of beam report for monitoring 501 and 502, transmitted by the network device 101, before transmission of the RSs. After the terminal device receives the indication, the next one JIM beam report indicated by the indication is monitoring-based reporting. For example, the network device can use the “CSI request” filed in Downlink Control Information (DCI) to indicate an access point (AP) trigger state associated with the JIM beam report. The DCI is scrambled with a new Radio Network Temporary Identity (RNTI), or a specific RNTI. This way, the timing of beam report of model inference and model monitoring can be controlled so flexibly.

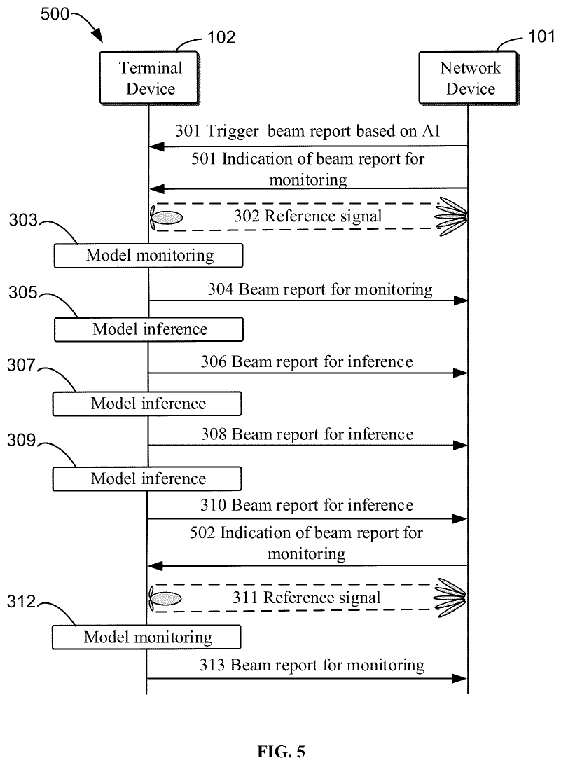

FIG. 6 illustrates an example of a process flow for beam reporting based on artificial intelligence prediction in accordance with some example embodiments of the present disclosure. In example embodiments of the present disclosure, the operations 301, 302, . . . , and 313 in FIG. 6 are the same with those in FIG. 3. The terminal device 102 can determine the reporting type to be model monitoring by a dynamic indication from the network device 101. In FIG. 6, the dynamic indication can be an activation and a deactivation of beam report for monitoring. At 601, the network device 101 transmits an activation of beam report for monitoring to the terminal device 102, then transmits RSs at 302. In response to the reception of the activation of beam report for monitoring, the terminal device 102 implements model monitoring, then transmits beam report for monitoring at 304. The terminal device 102 repeats model monitoring, and transmission of beam report for monitoring, until reception of deactivation of beam report for monitoring, at 602.

In example embodiments of the present disclosure, the timing of beam report for inference and monitoring can be controlled based on two dynamic indications: activation indication for model monitoring and deactivation for model monitoring. Optionally, an indication for model monitoring and an indication for model inference.

In example embodiments of the present disclosure, after the terminal device 102 receives the activation indication for model monitoring, (and after the control command carrying the indication takes effect), the terminal device 102 starts to perform model monitoring, it means that the next JIM beam report is monitoring-based reporting. After the terminal device 102 receives the deactivation indication for model monitoring, the terminal device 102 stops performing model monitoring, and the next JIM beam report is inference-based reporting. Further, the indications can be carried by a DCI or Media Access Control-Control Element (MAC-CE). For example, a new MAC-CE can be introduced. And the new MAC-CE includes two indications: activation and deactivation for model monitoring. A new field (e.g., 1 bit) can be introduced in DCI. “1” and “0” refer to activation and deactivation for model monitoring. Or, it is reasonable to reuse “CSI request” filed in DCI to indicate activation and deactivation for model monitoring. Extend 1 bit in “CSI request” filed, “1” and “0” refer to activation and deactivation for model monitoring. “111” and “000” in “CSI request” filed refer to activation and deactivation for model monitoring. Meanwhile, the DCI is scrambled with a new RNTI or a specific RNTI. This way, the timing of beam report of model inference and model monitoring can be controlled so flexibly.

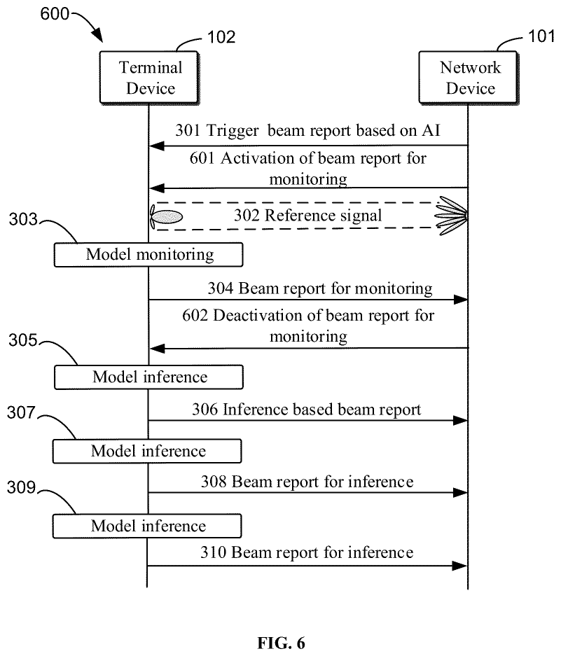

FIG. 7 illustrates an example of a process flow for beam reporting based on artificial intelligence prediction in accordance with some example embodiments of the present disclosure. In example embodiments of the present disclosure, the operations 301, 302, . . . , and 313 in FIG. 7 are the same with those in FIG. 3. The terminal device 102 can determine the reporting type to be model monitoring by receiving the first set of reference signals from the network device. In response to receiving the RSs, the terminal device 102 generate the third beam report for monitoring. In response to not receiving the RSS, the terminal device 102 generate the first beam report for inference.

In example embodiments of the present disclosure, the terminal device 102 can be configured with RSs having a period that is different from the period of the beam report. If the terminal device 102 receives the RSs associated with the JIM beam report between the JIM beam report and the latest JIM beam report, the JIM beam report is monitoring-based reporting. If the terminal device 102 does not receive the RSs associated with the JIM beam report between the JIM beam report and the latest JIM beam report, the JIM beam report is inference-based reporting. Therefore, the terminal device 102 can determine whether the JIM beam report is monitoring or inference-based beam reporting based on whether the RSs associated with the JIM beam report is received. This way, the timing of beam report of model inference and model monitoring can be controlled so flexibly.

In example embodiments of the present disclosure, the dynamic indication can be indicated by a Downlink Control Information (DCI) in Physical Downlink Control Channel (PDCCH). The dynamic indication can also be indicated by a Media Access Control-Control Element (MAC-CE).

In example embodiments of the present disclosure, the number of CPUs needed for model inference can be P, and the number of CPUs needed for model monitoring can be P+1, which is one more than model inference, for the measurement of the RSs. The “P” refers to an integer greater than or equal to 0.

In example embodiments of the present disclosure, O_{CPU}=1 for a beam report with CSI-ReportConfig with higher layer parameter reportQuantity set to “cri-RSRP”, “ssb-Index-RSRP”, “cri-SINR”, “ssb-Index-SINR” or ‘none’, and CSI-RS-ResourceSet with higher layer parameter trs-Info not configured, and the beam report is not indicated for AI beam reporting.

O_{CPU}=P for a beam report with CSI-ReportConfig with higher layer parameter reportQuantity set to “cri-RSRP”, “ssb-Index-RSRP”, “cri-SINR”, “ssb-Index-SINR” or “none”, and CSI-RS-ResourceSet with higher layer parameter trs-Info not configured, and the beam report is indicated for model inference.

O_{CPU}=1+P for a beam report with CSI-ReportConfig with higher layer parameter reportQuantity set to “cri-RSRP”, “sab-Index-RSRP”, “cri-SINR” “ssb-Index-SINR” or “none”, and CSI-RS-ResourceSet with higher layer parameter trs-Info not configured, and the beam report is indicated for model monitoring.

This way. the CPU resource of for model inference and model monitoring can be determined efficiently

In example embodiments of the present disclosure, the terminal device 102 can determine that the beam report is a JIM beam report, if at least one of the following conditions are met: the terminal device 102 reports AI-related capabilities, e.g., capabilities indicating that UE supports AI/Machine Learning (ML), model inference, model monitoring, joint model inference and model monitoring, beam prediction based on position information. The terminal device 102 is configured with AI-related configuration by the network device 101, e.g., enable parameters indicating AI/ML/model inference/model monitoring/joint model inference and model monitoring/beam prediction based on position information. The period of the RSs configured in the beam report is different from the period of the beam report. The terminal device 102 is configured with the monitoring/inference specific offset and period, or the cycle duration including a monitoring duration and an inference duration.

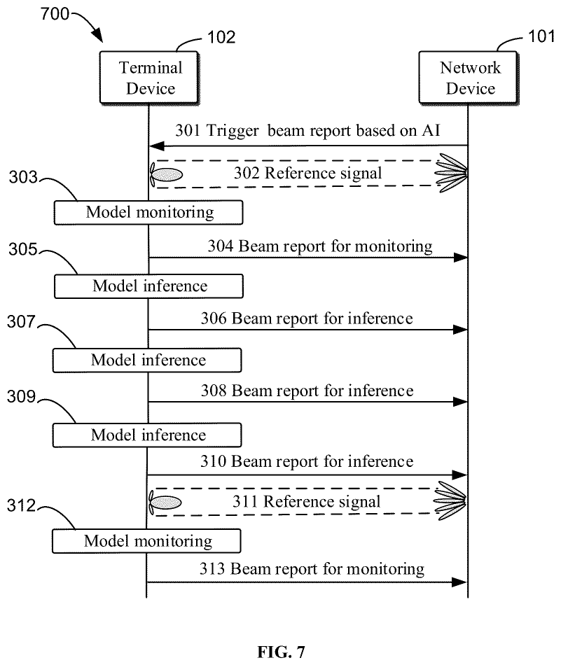

FIG. 8 illustrates an example of a method 800 implemented at a terminal device in accordance with some example embodiments of the present disclosure. For the purpose of discussion, the method 800 will be described from the perspective of the terminal device 102 with reference to FIG. 1B.

In example embodiments of the present disclosure, in block 801, the terminal device 102 receives, a configuration for a first beam report from the network device 101. In block 802, the terminal device 102 generates the first beam report using an artificial intelligence (AI) model without performing a beam measurement on a first set of reference signals associated with the first beam report. In block 803, the terminal device 102 transmits the first beam report to the network device 101.

In one embodiment, the terminal device 102 further omits receiving the set of reference signals from the network device.

In one embodiment, the first beam report includes Channel State Information (CSI)—Reference Signal (RS) Resource Indicators (CRIs) or Synchronization Signal (SS)/Physical Broadcast Channel (PBCH) Block Resource Indicators (SSBRIs).

In one embodiment, in response to determining that transmitting the first beam report conflicts with transmitting a second beam report, the terminal device 102 further transmits one of the first beam report and the second beam report based on a comparison between a first priority of the first beam report and a second priority of the second beam report.

In one embodiment, the first priority and the second priority are determined based on at least one of: whether the first beam report comprises CRIs or SSBRIs, whether the first beam report is generated using the AI model.

In one embodiment, transmitting the first beam report comprises: transmitting, periodically or semi-persistently, a plurality of beam reports, the first beam report being one of the plurality of beam reports.

In one embodiment, in response to receiving the first set of reference signals before transmitting the first beam report and after transmitting a recent beam report, the terminal device 102 further generates the first beam report to include at least one of CRIs. SSBRIs, Layer 1 Reference Signal Received Powers (L1-RSRPs) and Layer 1 Signal to Interference plus Noise Ratios (L1-SINRs).

In one embodiment, in response to not receiving the first set of reference signals before transmitting the first beam report and after transmitting a recent beam report, the terminal device 102 further generates the first beam report to include at least one of CRIs and SSBRIs.

In one embodiment, the terminal device 102 further determines the first set of reference signals associated with the first beam report based on a second set of reference signals configured in a second beam report.

In one embodiment, the second beam report satisfies at least one of the following conditions: the second beam report is closest to the first beam report in time domain, the second beam report is not generated using the AI model, the number of reference signals in the second set of reference signals is less than or equal to a predefined threshold, the second beam report is indicated by an index of a CSI report configured in the first beam report.

In one embodiment, the method as above, the terminal device 102 further determines the first set of reference signals associated with the first beam report based on a second set of reference signals.

In one embodiment, the second set of reference signals satisfy at least one of the following conditions: the second set of reference signals are associated with a repetition configuration, the second set of reference signals are closest to the first beam report in time domain, and the number of the reference signals in the second set of reference signals is less than or equal to a predefined threshold.

In one embodiment, the terminal device 102 further determines that the first beam report is to be generated using the AI model based on at least one of the following conditions: the configuration comprises AI related parameters, the configuration does not comprise the first set of reference signals, and the configuration comprises the first set of reference signals and the period of the first set of reference signals is different from the period of the first beam report.

In one embodiment, the first beam report is of a first reporting type for model inference.

In one embodiment, the terminal device 102 further generates, a third beam report without using the AI model with performing a beam measurement on the first set of reference signals associated with the first beam report, transmitting, to the network device, at least an indication of whether the AI model is available in the third beam report, the third beam report is of a second reporting type for model monitoring.

In one embodiment, the terminal device 102 expects to receive the first set of reference signals associated with the first beam report that is of the second reporting type for model monitoring.

In one embodiment, the number of CPUs occupied by processing of model monitoring is one more than the number of CPUs occupied by processing of model inference.

In one embodiment, the terminal device 102 further determines the reporting type to be model monitoring based on at least one of: an offset and a period for model monitoring, a cycle duration including a time duration for model inference and a time duration for model monitoring, a dynamic indication from the network device, receiving the first set of reference signals from the network device.

In one embodiment, the dynamic indication is indicated by a Downlink Control Information (DCI) or a Media Access Control-Control Element (MAC-CE).

In one embodiment, the DCI is scrambled with a specific Radio Network Temporary Identity (RNTI).

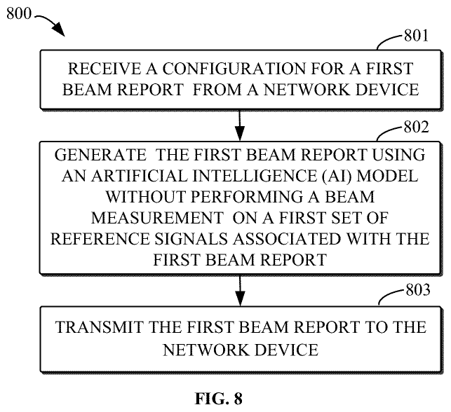

FIG. 9 illustrates an example of a method 900 implemented at a network device in accordance with some example embodiments of the present disclosure. For the purpose of discussion, the method 900 will be described from the perspective of the network device 101 with reference to FIG. 1B.

In block 901, the network device 101 transmits a configuration for a first beam report to the terminal device 102. In block 902, the network device 101 receives the first beam report for the network device from the terminal device 102, the first beam report being generated using an artificial intelligence (AI) model without performing a beam measurement on a first set of reference signals associated with the first beam report.

In one embodiment, the network device 101 further omits transmitting the set of reference signals to the terminal device 102.

In one embodiment. the network device 101 further receives, from the terminal device 102, an indication of whether an AI model in the terminal device 102 is available.

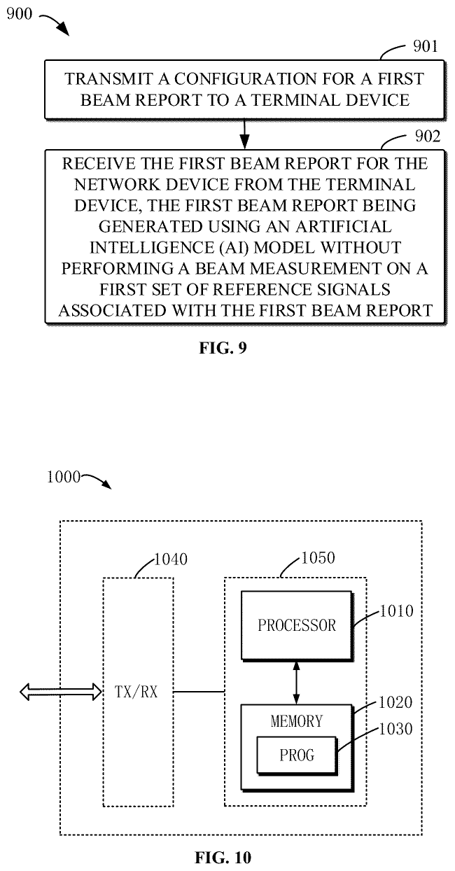

FIG. 10 illustrates a simplified block diagram of a device 1000 that is suitable for implementing embodiments of the present disclosure. The device 1000 can be considered as a further example implementation of the terminal device 102, and the network device 101 as shown in FIG. 1B. Accordingly, the device 1000 can be implemented at or as at least a part of the terminal device 102, or the network device 101.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 2-9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general-purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In summary, embodiments of the present disclosure may provide the following solutions.

A method of communication, comprises: receiving, at a terminal device, a configuration for a first beam report from a network device; generating, the first beam report using an artificial intelligence (AI) model without performing a beam measurement on a first set of reference signals associated with the first beam report; and transmitting the first beam report to the network device.

In one embodiment, the method as above, further comprises: omitting receiving the set of reference signals from the network device.

In one embodiment, the method as above, the first beam report includes Channel State Information (CSI)-Reference Signal (RS) Resource Indicators (CRIs) or Synchronization Signal (SS)/Physical Broadcast Channel (PBCH) Block Resource Indicators (SSBRIs).

In one embodiment, the method as above, further comprises: in response to determining that transmitting the first beam report conflicts with transmitting a second beam report, transmitting one of the first beam report and the second beam report based on a comparison between a first priority of the first beam report and a second priority of the second beam report.

In one embodiment, the method as above, the first priority and the second priority are determined based on at least one of: whether the first beam report comprises CRIs or SSBRIs, whether the first beam report is generated using the AI model.

In one embodiment, the method as above, transmitting the first beam report comprises: transmitting, periodically or semi-persistently, a plurality of beam reports, the first beam report being one of the plurality of beam reports.

In one embodiment, the method as above, further comprises: in response to receiving the first set of reference signals before transmitting the first beam report and after transmitting a recent beam report, generating the first beam report to include at least one of CRIs, SSBRIs, Layer 1 Reference Signal Received Powers (L1-RSRPs) and Layer 1 Signal to Interference plus Noise Ratios (L1-SINRs).

In one embodiment, the method as above, further comprises: in response to not receiving the first set of reference signals before transmitting the first beam report and after transmitting a recent beam report, generating the first beam report to include at least one of CRIs and SSBRIs.

In one embodiment, the method as above, further comprises: determining the first set of reference signals associated with the first beam report based on a second set of reference signals configured in a second beam report.

In one embodiment, the method as above, the second beam report satisfies at least one of the following conditions: the second beam report is closest to the first beam report in time domain, the second beam report is not generated using the AI model, the number of reference signals in the second set of reference signals is less than or equal to a predefined threshold, the second beam report is indicated by an index of a CSI report configured in the first beam report.

In one embodiment, the method as above, further comprises: determining the first set of reference signals associated with the first beam report based on a second set of reference signals.

In one embodiment, the method as above, the second set of reference signals satisfy at least one of the following conditions: the second set of reference signals are associated with a repetition configuration, the second set of reference signals are closest to the first beam report in time domain, and the number of the reference signals in the second set of reference signals is less than or equal to a predefined threshold.

In one embodiment, the method as above, further comprises: determining that the first beam report is to be generated using the AI model based on at least one of the following conditions: the configuration comprises AI related parameters, the configuration does not comprise the first set of reference signals, and the configuration comprises the first set of reference signals and the period of the first set of reference signals is different from the period of the first beam report.

In one embodiment, the method as above, the first beam report is of a first reporting type for model inference.

In one embodiment, the method as above, further comprises: generating, a third beam report without using the AI model with performing a beam measurement on the first set of reference signals associated with the first beam report, transmitting, to the network device, at least an indication of whether the AI model is available in the third beam report, the third beam report is of a second reporting type for model monitoring.

In one embodiment, the method as above, the terminal device expects to receive the first set of reference signals associated with the first beam report that is of the second reporting type for model monitoring.

In one embodiment, the method as above, the number of CPUs occupied by processing of model monitoring is one more than the number of CPUs occupied by processing of model inference.

In one embodiment, the method as above, further comprises: determining the reporting type to be model monitoring based on at least one of: an offset and a period for model monitoring, a cycle duration including a time duration for model inference and a time duration for model monitoring, a dynamic indication from the network device, receiving the first set of reference signals from the network device.

In one embodiment, the method as above, the dynamic indication is indicated by a Downlink Control Information (DCI) or a Media Access Control-Control Element (MAC-CE).

In one embodiment, the method as above, the DCI is scrambled with a specific Radio Network Temporary Identity (RNTI).

A method of communication, comprises: transmitting, at a network device, a configuration for a first beam report to a terminal device; and receiving, the first beam report for the network device from the terminal device, the first beam report being generated using an artificial intelligence (AI) model without performing a beam measurement on a first set of reference signals associated with the first beam report.

In one embodiment, the method as above, further comprises: omitting transmitting the set of reference signals to the terminal device.

In one embodiment, the method as above, further comprises: receiving, from the terminal device, an indication of whether an AI model in the terminal device is available.

1. A method of communication, comprising:
receiving, at a terminal device, a configuration for a first beam report from a network device;
generating, at a terminal device, the first beam report using an artificial intelligence (AI) model without performing a beam measurement on a first set of reference signals associated with the first beam report; and
transmitting the first beam report to the network device.

2. The method of claim 1, further comprising:
omitting receiving the set of reference signals from the network device.

3. The method of claim 1, wherein the first beam report includes Channel State Information (CSI)—Reference Signal (RS) Resource Indicators (CRIs) or Synchronization Signal (SS)/Physical Broadcast Channel (PBCH) Block Resource Indicators (SSBRIs).

4. The method of claim 1, further comprising:
in response to determining that transmitting the first beam report conflicts with transmitting a second beam report, transmitting one of the first beam report and the second beam report based on a comparison between a first priority of the first beam report and a second priority of the second beam report.

5. The method of claim 1, wherein the priority associated with the first beam report is determined based on at least one of:
whether the first beam report comprises CRIs or SSBRIs, and
whether the first beam report is generated using the AI model.

6. The method of claim 1, wherein transmitting the first beam report comprises:
transmitting, periodically or semi-persistently, a plurality of beam reports, the first beam report being one of the plurality of beam reports.

7. The method of claim 6, further comprising:
in response to receiving the first set of reference signals before transmitting the first beam report and after transmitting a recent beam report, generating the first beam report to include at least one of CRIs, SSBRIs, Layer 1 Reference Signal Received Powers (L1-RSRPs) and Layer 1 Signal to Interference plus Noise Ratios (L1-SINRs).

8. The method of claim 6, further comprising:
in response to not receiving the first set of reference signals before transmitting the first beam report and after transmitting a recent beam report, generating the first beam report to include at least one of CRIs and SSBRIs.

9. The method of claim 1, further comprising:
determining the first set of reference signals associated with the first beam report based on a second set of reference signals configured in a second beam report.

10. The method of claim 9, wherein the second beam report satisfies at least one of the following conditions:
the second beam report is closest to the first beam report in time domain,
the second beam report is not generated using the AI model,
the number of reference signals in the second set of reference signals is less than or equal to a predefined threshold, and
the second beam report is indicated by an index of a CSI report configured in the first beam report.

11. The method of claim 1, further comprising:
determining the first set of reference signals associated with the first beam report based on a second set of reference signals.

12. The method of claim 11, wherein the second set of reference signals satisfies at least one of the following conditions:
the second set of reference signals is associated with a configuration of repetition,
the second set of reference signals is closest to the first beam report in time domain, and
the number of the reference signals in the second set of reference signals is less than or equal to a predefined threshold.

13. The method of claim 1, further comprising determining that the first beam report is to be generated using the AI model based on at least one of the following conditions:
the configuration comprises AI related parameters,
the configuration does not comprise the first set of reference signals, and
the configuration comprises the first set of reference signals and the period of the first set of reference signals is different from the period of the first beam report.

14. The method of claim 1, wherein the first beam report is of a first reporting type for model inference.

15. The method of claim 1, further comprising:
generating, a third beam report without using the AI model with performing a beam measurement on the first set of reference signals associated with the first beam report,
transmitting, to the network device, at least an indication of whether the AI model is available in the third beam report,
the third beam report is of a second reporting type for model monitoring.

16. The method of claim 15, wherein
the terminal device expects to receive the first set of reference signals associated with the first beam report that is of the second reporting type for model monitoring.

17. The method of claim 15, wherein
the number of CPUs occupied by processing of model monitoring is one more than the number of CPUs occupied by processing of model inference.

18. The method of claim 15, further comprising determining whether the first beam report is of the second reporting type for model monitoring based on at least one of:
an offset and a period for model monitoring,
a cycle duration including a time duration for model inference and a time duration for model monitoring,
a dynamic indication from the network device, and
receiving the first set of reference signals from the network device.

19.-20. (canceled)

21. A method of communication, comprising:
transmitting, at a network device, a configuration for a first beam report to a terminal device; and
receiving, the first beam report for the network device from the terminal device, the first beam report being generated using an artificial intelligence (AI) model without performing a beam measurement on a first set of reference signals associated with the first beam report.

22.-23. (canceled)

24. A terminal device comprising:
a processor; and
a memory storing computer program codes;
the memory and the computer program codes configured to, with the processor, cause the terminal device to:
receive a configuration for a first beam report from a network device;
generate the first beam report using an artificial intelligence (AI) model without performing a beam measurement on a first set of reference signals associated with the first beam report; and
transmit the first beam report to the network device.

25.-26. (canceled)
